(19) United States
(12) Patent Application Publication
(10) Pub. No.: US 2021/0169222 A1
(43) Pub. Date: Jun. 10, 2021

(54) SECRET STORAGE FURNITURE ARTICLE

(71) Applicant: Taneshia Pawelczak, Middle Village, NY (US)

(72) Inventor: Taneshia Pawelczak, Middle Village, NY (US)

(21) Appl. No.: 17/182,116

(22) Filed: Feb. 22, 2021

Related U.S. Application Data
(63) Continuation-in-part of application No. 16/183,705, filed on Nov. 7, 2018.
(60) Provisional application No. 62/582,648, filed on Nov. 7, 2017.

(51) Int. Cl. A47B 88/80; E05B 47/00; G07C 9/00

(52) U.S. Cl. CPC A47B 88/80; E05B 2047/0088; G07C 9/00563; E05B 47/00

(57) ABSTRACT

A dresser for discretely securing items; the dresser for discretely securing items includes a housing with at least two visible drawers, a dresser top having a hidden drawer, a latch mechanism, and an opener. In one embodiment, the opener is a lock and key. In another embodiment, the opener is a fingerprint scanner. The dresser provides a safe, secured, discreet way to store personal belongings of value, including money and jewelry.

### CROSS-REFERENCE TO RELATED APPLICATION

The present application is related to and claims priority to U.S. Non-Provisional patent application Ser. No. 16/183,705, filed on Nov. 7, 2018, pending, which is related to and claims priority to U.S. Provisional Patent Application No. 62/582,648 filed Nov. 7, 2017, both of which are incorporated by reference in their entirety.

### BACKGROUND OF THE INVENTION

The following includes information that may be useful in understanding the present disclosure. It is not an admission that any of the information provided is prior art or material to the presently described or claimed inventions or any expressly or implicitly referenced publication or document is prior art.

### FIELD OF THE INVENTION

The present invention generally relates to furniture and more specifically relates to furniture with a secret storage compartment.

### DESCRIPTION OF RELATED ART

When a house is burglarized, the most likely theft targets have a relatively small size and weight but high monetary value. For obvious reasons, a thief is more inclined to take jewelry, other precious metals, cash, etc., in favor of larger and heavier items that are more difficult to transport and conceal. People are always looking for inconspicuous ways to store their valuable personal belongings around a home. Some people may invest in a safe, but such storage methods can be expensive, conspicuous, and aren't practical for everyone. Additionally, small safes can be removed from a home. Some people may hide their belongings in different, unsuspecting places, but it can be a hassle to find these belongings when they're needed. A suitable solution is desired.

U.S. Pat. No. 5,944,396 to Gerald H. Stephan relates to furniture having a concealed drawer with a dual stage locking mechanism. The described furniture having a concealed drawer with a dual stage locking mechanism includes a front drawer that is revealed. The front drawer is received within a receptacle defined by a lateral partition disposed proximately at the center of the furniture and a pair of oppositely disposed side aprons. The lateral partition serves to hide the concealed drawer in the event the front drawer is removed. A stop is pivotally mounted to the upper end of the back wall of the front drawer to limit the forward travel of the front drawer out of the receptacle. A first locking mechanism includes a push button, key operated lock which is locked simply by pushing a button and is unlocked using a key. The first locking mechanism may be disposed on either the bottom of the furniture or on the lateral interior partition of the furniture. A second locking mechanism consists of a magnetically operated lock configured to open when a magnet of an opposite pole from a magnet incorporated in the second locking mechanism is placed near the second locking mechanism.

### BRIEF SUMMARY OF THE INVENTION

Given the preceding disadvantages inherent in the known furniture art, the present disclosure provides a novel secret storage device. The general purpose of the present disclosure, which will be described subsequently in greater detail, is to provide a safe, secured, discreet way to store personal belongings of value, including money and jewelry.

An article of furniture is disclosed. The dresser includes a housing which may include a first inner capacity defined by a bottom surface relative to a floor surface, a first sidewall, a second sidewall opposite the first sidewall, a rear wall, and a first open front opposite the rear wall. The first inner capacity may be configured to slideably receive at least two visible drawers via the first open front. A dresser top may be attached to the top of the housing. It may include a second inner capacity defined by a top surface, a first side surface, a second side surface opposite the first side surface, a rear surface, and a second open front opposite the rear surface. The second inner capacity may be configured to receive the hidden drawer via the second open front.

A latch mechanism may be attached to the dresser top's inner surface in communication with the hidden drawer. The latch mechanism may be configured to selectively lock and unlock the hidden drawer within the second inner capacity. Further, an opener may be attached to the dresser top and in communication with the latch mechanism. The opener may be configured to actuate the latch mechanism to unlock the hidden drawer selectively.

A method of using the dresser is also disclosed. The method of using the dresser may comprise the steps of providing the dresser as above; using the opener to actuate the latch mechanism to unlock the hidden drawer selectively; placing an item of the items within the hidden drawer; shutting the hidden drawer, and selectively locking the hidden drawer with the opener.

In some versions, the article of furniture has a body containing visible drawers, a body top with one or more concealed top drawer including a concealed drawer front, a concealed latch bridging the body and the concealed drawer; a concealer; and a concealed opener in communication with the concealed latch and operable to lock or unlock the latch. In some versions, the concealed drawer sits flush with the sides of the body.

The opener can connect the controller, and either the controller or the opener is, in some versions, in wireless communication with a device running an app. The app contains code that causes the device to send a signal to the controller or the opener, causing the opener to lock or unlock the latch.

The opener can include a variety of locking mechanisms including a key mechanism or biometric sensor. The biometric sensor can include a fingerprint scanner, a face recognition scanner, or an iris recognition scanner.

In some versions, the concealed drawer has a depth that ranges from 2 to 5 inches. And the concealed drawer can be waterproof, fireproof, or both.

In some versions, the concealer sits or is concealed within a visible drawer, and in some of these versions, the opener is concealed by the concealer.

In other versions, the concealer is a concealed sliding panel adjacent to and flush with the concealed drawer, and in some of these versions, the concealed opener is concealed by the concealed sliding panel.

Among other locations, the concealed sliding panel can be located on the front of the body or body top in front of the concealed opener or can be on the side of the body top or body covering the concealed opener.

### BRIEF DESCRIPTION OF THE DRAWINGS

The figures that accompany the written portion of this specification illustrate embodiments and methods of use for the present disclosure, a secret storage article constructed and operative according to the present disclosure's teachings.

FIG. 1 is a side front perspective view of the dresser during an ‘in use’ condition.

FIG. 2 is a front perspective view of the dresser of FIG. 1.

FIG. 3 is a side-front perspective view of the dresser of FIG. 1.

FIG. 4A is a side perspective view of the dresser of FIG. 1.

FIG. 4B is a front perspective view of the dresser of FIG. 1.

FIG. 5A is a front perspective view of the dresser of FIG. 1.

FIG. 5B is a front perspective view of the dresser of FIG. 1.

FIG. 6 is a front perspective view of the dresser of FIG. 1.

FIG. 7 is a flow diagram illustrating a method of using the article.

The various embodiments of the present invention will be described with the appended drawings.

### DETAILED DESCRIPTION

As discussed above, the present disclosure's embodiments relate to furniture and, more particularly, to a secret storage article with a secret storage compartment.

Generally, disclosed is an article of furniture. This article can be a dresser and will be described as such throughout this disclosure. The dresser has a hidden or concealed compartment, including various locking methods, like biometric and key access. For purposes of this disclosure, a hidden or concealed drawer is a drawer not having a discernible presence; a hidden or concealed drawer front is a drawer front not having a discernible presence.

The present invention may virtually eliminate the need to store obvious and expensive items in a safe or to stash important items elsewhere around a home. This further saves a considerable amount of time and frustration retrieving personal items. The dresser may further withstand fire and water for maximum protection and security. The dresser may hide jewelry, money, and other personal belongings in plain sight without detection or access.

The dresser may function as an ordinary dresser but include at least two hidden compartments. The compartments, or drawers, can be located at the top or bottom of the dresser, do not have handles, and can sit flush with the dresser, creating the appearance of wooden seams within the dresser. The drawers may further include one of two methods of opening. One method can include using a key to trigger a spring latch and magnet system that ejects the drawers. The second method can include concealed biometric sensors, such as fingerprint scanners. Further, the dresser may be made from wood material, in various shades, having a modern look and clean finish that complements the décor of any room. The exact specifications may vary upon manufacturing.

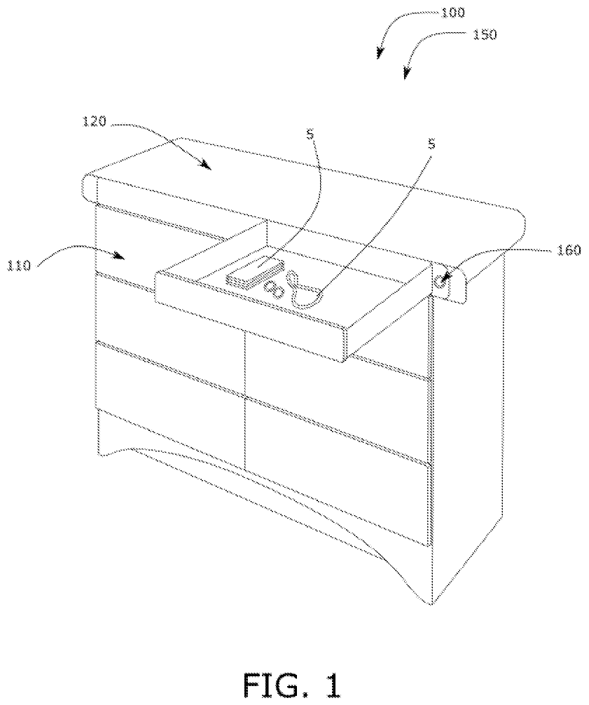

Referring now more specifically to the drawings by numerals of reference, there is shown in FIGS. 1-7, various views of a dresser 100.

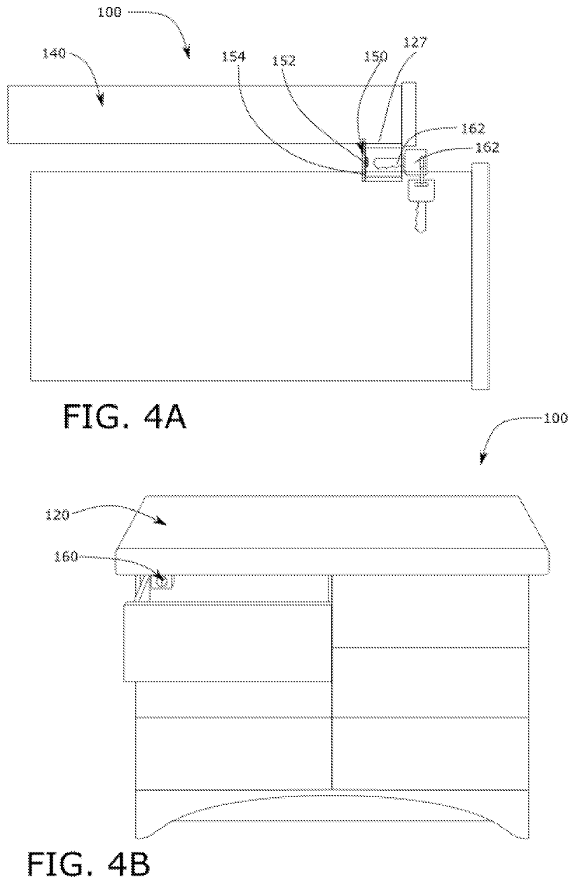

FIG. 1 shows a dresser 100 during an ‘in use’ condition 150. As illustrated, the dresser 100 may include a housing 110, a dresser top 120, a latch mechanism 150 (FIG. 4), and an opener 160. As shown, the dresser 100 may be used for discretely securing items 5.

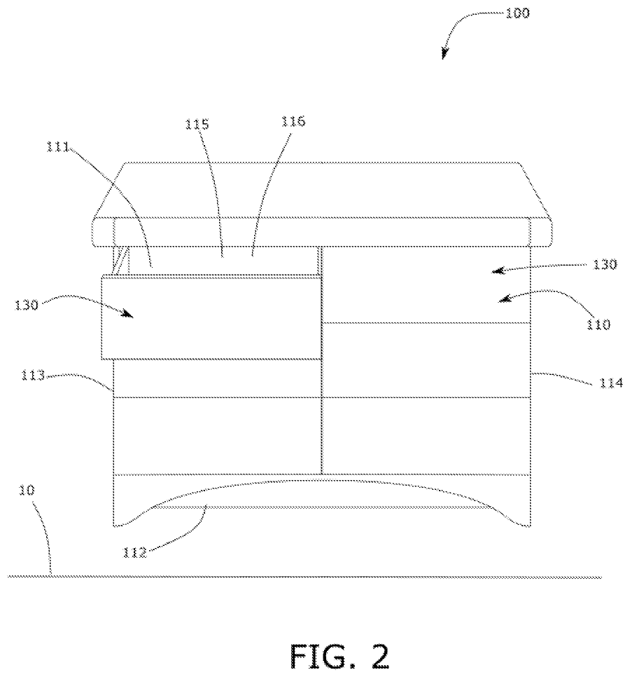

FIG. 2 shows a front perspective view of the dresser 100 of FIG. 1. The housing 110 may include a first inner capacity 111 defined by a bottom surface 112 relative to a floor surface 10, a second sidewall 114 opposite a first sidewall 113, a rear wall 115, and a first open front 116 opposite the rear wall. As shown, the first inner capacity 111 may be configured to slideably receive at least two visible drawers 130 via the first open front. In a preferred embodiment, the body or first inner capacity 111 of the housing 110 may be configured to receive one or more visible drawers 130. However, other amounts of visible drawers 130 are contemplated. For example, the first inner capacity 111 of the housing 110 may be configured to slideably receive less than six visible drawers 130 or more than six visible drawers 130.

Further, housing 110 may be made from wood. The wood may be natural wood such as maple, oak, mahogany, beech, etc. The wood material may be finished with a varnish or lacquer to provide a decorative appearance or to protect the wood material's surface and provide added durability to prevent scratches and nicks in the wood material. In another example, the wood material may be a manufactured wood. The manufactured wood may include a top layer of natural wood covered by a coating as above. The coating may be a melamine. The melamine coating may be useful for preventing scratches and nicks in the wood, and also may be useful for preventing burning of the wood material in the event of a fire. Under the top layer of natural may be a pressed wood material such as medium density fiberboard. In this example, the cost to manufacture may be less than using natural wood. Other materials may be used.

Further, in other embodiments, the housing 110 may be made from plastic materials, metal materials, or a mix of any two of the wood materials, plastic materials and metal materials.

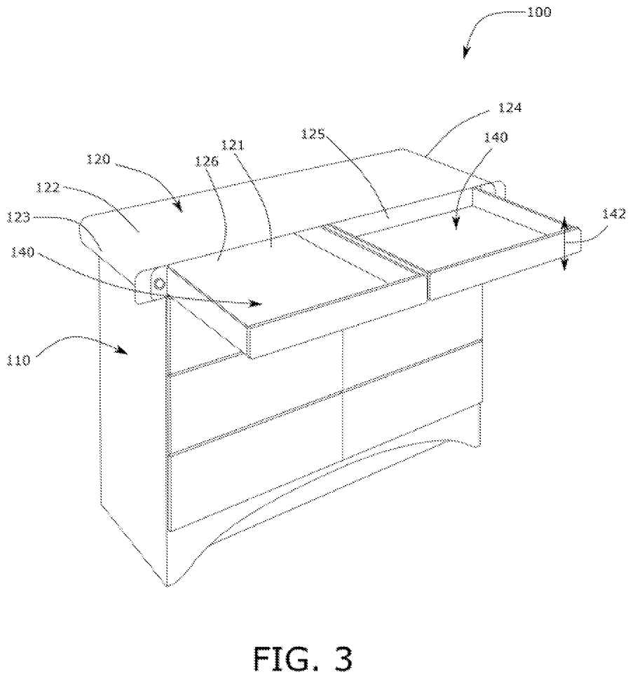

FIG. 3 shows a side front perspective view of the dresser 100 of FIG. 1. As shown in the preferred embodiment, the dresser top 120 may be attached to the top of the housing 110. The dresser top 120 may include a second inner capacity 121 defined by a top surface 122, a first side surface 123, a second side surface 124 opposite the first side surface 123, a rear surface 125, and a second open front 126. The inner capacity may be configured to slideably receive hidden drawer 140 via the second open front 126. As shown in the preferred embodiment, the second inner capacity 121 of the dresser top 120 may be configured to receive one or more hidden drawer 140s. However, any number of hidden drawers 140 are contemplated. The two hidden drawer 140s may sit flush with the first side surface 123, the second side surface 124, and the top surface 122 of the dresser top 120 such that the two hidden drawers 140 are undetectable to anyone who is unaware of their existence. In some exemplars, hidden or concealed means undetectable to those not aware of the drawer's existence.

As discussed above, housing 110 may be made from wood material. In the preferred embodiment, the dresser top 120 is foreseen to be made from the same material. Further, as discussed above, the wood material may be coated with a protective composition such as melamine to protect against burning. As such, in the preferred embodiment, the hidden drawer 140 may be fireproof and waterproof. This is particularly important for the hidden drawers 140, as they are foreseen to hold valuable items such as jewelry, money, computers, etc. The hidden drawer 140 may include a depth 142 of between 2-3 or 2-6 inches. However, other depths 142 are contemplated. In some embodiments, the hidden drawer 140 may be manufactured in various sizes depending on user preference.

FIGS. 4A-4B show side and front perspective views of the dresser 100 of FIG. 1. The latch mechanism 150 may be attached to an inner surface 127 of the dresser top 120 and in communication with the hidden drawer 140. The latch mechanism 150 may be configured to selectively lock and unlock the hidden drawer 140 within the second inner capacity 121. In the preferred embodiment, the latch mechanism 150 may include a spring latch 152 and a magnet system 154 configured to eject the hidden drawer 140 when the latch mechanism 150 is actuated.

Further, as shown, the opener 160 may be attached to the dresser top 120 and in communication with the latch mechanism 150. The opener 160 may be configured to actuate the latch mechanism 150 to lock or unlock the hidden drawer 140. In one embodiment, the opener 160 may be located within a visible drawer 130. Further, as shown, in one embodiment, the opener 160 may include a lock and key mechanism 162, whereby the lock is connected to the latch mechanism 150. Upon insertion of the key into the lock, the spring latch 152 and the magnet system 154 may eject the hidden drawer 140.

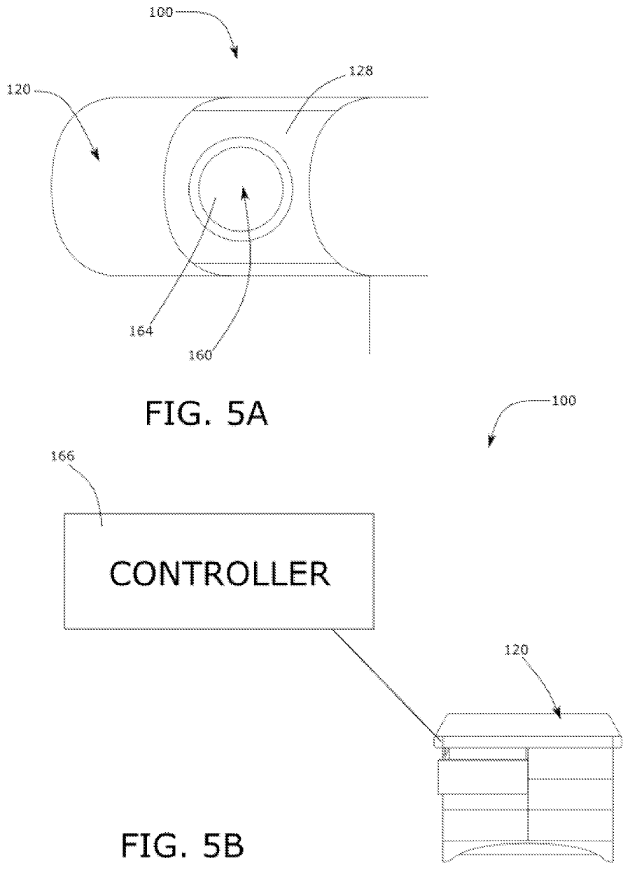

FIGS. 5A-5B show front perspective views of the dresser 100 of FIG. 1. As shown here, in another embodiment, the opener 160 may be located on a front surface 128 of the dresser top 120. In this embodiment, the opener 160 is preferably hidden until revealed by the user of the dresser. Further, in one embodiment, the opener 160 may include a biometric sensor 164. The biometric sensor 164 may include a fingerprint scanner, a face recognition scanner or an iris recognition scanner. Other biometric sensors 164 are also contemplated, for example, DNA, retina, palm print, odor, voice, etc. It should also be appreciated that any future advancements in biometric sensor 164 technology may also be included.

In addition, in this embodiment, the dresser may further include a controller 166 communicably coupled to the opener 160 and configured to recognize an input at the biometric sensor 164 and output a command. For example, the biometric sensor 164 may receive an input such as a fingerprint on the fingerprint scanner, compare the fingerprint with a correct fingerprint in the memory of the controller 166, verify whether the fingerprint is a match, and then actuate the latch mechanism 150 (FIG. 4A) to open the hidden drawer 140 (FIG. 4A) if it is a match. If the fingerprint is not a match, the controller 166 may output an alert such as an audible alarm, or silent alarm to another room, or a remote device accessible to the user, for example, a notification on a smartphone. In some versions, the opener or controller interfaces with a mobile phone or other device operating an app that controls the opener without a physical connection between the device having the app and the opener. In variations of this exemplar, the device having the app may connect to the opener or controller using any known communication protocol, e. g. BlueTooth.

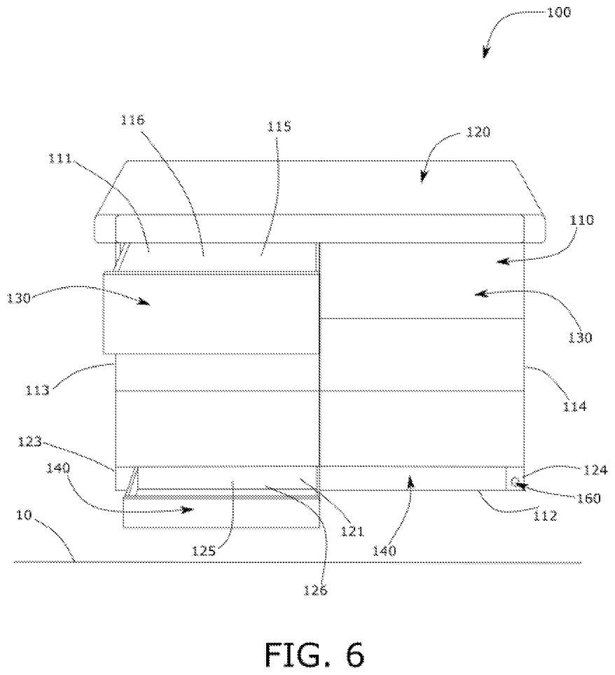

FIG. 6 shows a front perspective view of the dresser 100 of FIG. 1, according to an alternative embodiment of the present disclosure. In this embodiment, the housing 110 may include the first inner capacity 111 defined by the bottom surface 112 relative to the floor surface 10, the second sidewall 114 opposite the first sidewall 113, the rear wall 115 and the first open front 116 opposite the rear wall 115. The first inner capacity 111 may be configured to slideably receive at least two visible drawers 130 via the first open front. The dresser may include a dresser bottom (rather than the dresser top 120 discussed above) in this embodiment. As shown, the dresser bottom may be attached to the bottom surface 112 of the housing 110, the dresser bottom including the second inner capacity 121 defined by the bottom surface 112, the first side surface 123, a second side surface 124 opposite the first side surface 123, the rear surface 125 and the second open front 126, and the inner capacity may be configured to slideably receive the hidden drawer 140 via the second open front 126.

Further, the latch mechanism 150 (FIG. 4A) may be attached to an inner surface 127 of the dresser bottom and in communication with the hidden drawer 140; the latch mechanism 150 configured to selectively lock and unlock the hidden drawer 140 within the second inner capacity 121. The opener 160 may be attached to the dresser bottom and in communication with the latch mechanism 150; the opener 160 is configured to actuate the latch mechanism 150 (FIG. 4A) to unlock the hidden drawer 140.

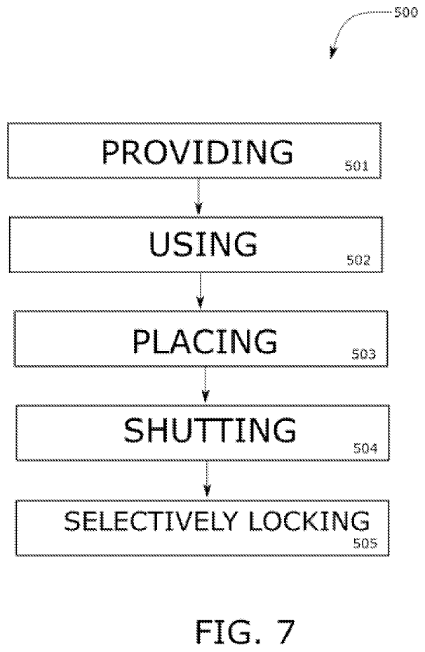

FIG. 7 is a flow diagram illustrating a method of using a dresser for discretely securing items 700. As illustrated, the method of using a dresser for discretely securing items 700 may include the steps of step one 701, providing the dresser 100 as above; step two 702, using the opener 160 to actuate the latch mechanism 150 to unlock the hidden drawer 140; step three 703, placing of an item of the items 5 within the hidden drawer 140; step four 704, shutting the hidden drawer 140; and step five 705, selectively locking the hidden drawer 140 with the opener 160.

It should be noted that the steps described in the method of use can be carried out in many different orders according to user preference.

What is claimed is:

1. An article of furniture comprising:
a body having at least two visible drawers;
a body top having a concealed top section drawer including a concealed drawer front;
a concealed latch bridging the body and the concealed drawer;
a concealer;
and
a concealed opener in communication with the concealed latch and operable to lock or unlock the latch.

2. The article of claim 1, wherein the concealed drawer sits flush with sides of the body.

3. The article of claim 2 further comprising a controller in communication with the opener.

4. The article of claim 3, wherein the controller or the opener is in wireless communication with a device running an app, and the app contains code that causes the device to send a signal to the controller or the opener, causing the opener to lock or unlock the latch.

5. The article of claim 4, wherein the opener includes a key mechanism.

6. The article of claim 5, wherein the opener includes a biometric sensor.

7. The article of claim 6, wherein the biometric sensor includes a fingerprint scanner, a face recognition scanner, or an iris recognition scanner.

8. The article of claim 7, wherein a depth of the concealed drawer ranges from 2-5 inches.

9. The article of claim 8, wherein the concealed drawer is fireproof or waterproof.

10. The article of claim 9, wherein the body comprises additional visible drawers.

11. The article of claim 10, wherein the body top further comprises additional concealed top section drawer including a concealed drawer front.

12. The article of claim 11, wherein the concealer sits within a visible drawer.

13. The article of claim 12, wherein the concealer is concealed within a visible drawer.

14. The article of claim 13 wherein the opener is concealed by the concealer.

15. The article of claim 11, wherein the concealer is a concealed sliding panel adjacent to and flush with the concealed drawer.

16. The article of claim 15, wherein the concealed opener is concealed by the concealed sliding panel.

17. The article of claim 16, wherein the concealed sliding panel is located on a front of the body top in front of the concealed opener.
